(19) United States
(12) Patent Application Publication
(10) Pub. No.: US 2024/0119808 A1
(43) Pub. Date: Apr. 11, 2024

(54) PRESENTATION DEVICE AND GAMING MACHINE

(71) Applicant: OMRON Corporation, KYOTO (JP)

(72) Inventors: Masaaki SUMI, Kyoto-shi (JP); Eiji YASUDA, Ichinomiya-shi (JP); Takahiro ONO, Kyoto-shi (JP); Takuya KUDO, Kyoto-shi (JP); Takehiro AGATA, Kyoto-shi (JP)

(73) Assignee: OMRON Corporation, KYOTO (JP)

(21) Appl. No.: 18/461,500

(22) Filed: Sep. 5, 2023

(30) Foreign Application Priority Data
Oct. 11, 2022 (JP) 2022-163379

(51) Int. Cl. G07F 17/34; G07F 17/32

(52) U.S. Cl. CPC G07F 17/34; G07F 17/3213

(57) ABSTRACT

A presentation device is provided in a gaming machine. The presentation device includes: a small roulette wheel, a medium roulette wheel, and a large roulette wheel, having different diameters and rotatably held on the same rotation center line; a motor, rotating each roulette wheel; a communication part, transmitting and receiving a control signal to and from the gaming machine; and a control part, controlling the motor based on the control signal from the gaming machine.

### CROSS-REFERENCE TO RELATED APPLICATIONS

This application claims the priority benefit of Japan Application No. 2022-163379, filed on Oct. 11, 2022. The entirety of the above-mentioned patent application is hereby incorporated by reference herein and made a part of this specification.

### BACKGROUND

### Technical Field

The disclosure relates to a presentation device and a gaming machine.

### Related Art

Conventionally, there has been proposed a gaming machine or the like provided with various presentation devices. For example, in a gaming machine of Patent Document 1 (Japanese Patent Laid-Open No. 2020-92891), a roulette accessory as a presentation part is provided inside a push button. The roulette accessory notifies a player of a result of a sub-game lottery according to a state when rotation is stopped.

The roulette accessory of Patent Document 1 has a configuration in which only one roulette wheel is arranged inside the push button, and there is room for improvement in terms of player interest and visibility.

### SUMMARY

A presentation device according to one aspect of the disclosure is a presentation device provided in a gaming machine. The presentation device includes: a plurality of roulette wheels, having different diameters from each other and rotatably held on the same rotation center line; a plurality of motors, rotating the plurality of roulette wheels; a communication part, transmitting and receiving a control signal to and from the gaming machine; and a control part, controlling the plurality of motors based on the control signal received by the communication part from the gaming machine.

### BRIEF DESCRIPTION OF THE DRAWINGS

FIG. 1 is a schematic perspective view of a gaming machine provided with a presentation device according to an embodiment of the disclosure.

FIG. 2 is an enlarged front view of the presentation device of FIG. 1.

FIG. 3 is an exploded perspective view of the presentation device of FIG. 1.

FIG. 4 is a side cross-sectional view of the presentation device of FIG. 1.

FIG. 5 is an exploded perspective view of a peripheral member of each roulette wheel of the presentation device of FIG. 1.

FIG. 6 is a perspective view illustrating a longitudinal section of a peripheral member of each motor of the presentation device of FIG. 1.

FIG. 7 is an exploded perspective view of a peripheral member of each motor of the presentation device of FIG. 1.

FIG. 8 is a block diagram illustrating an electrical configuration of the gaming machine of FIG. 1.

FIG. 9 is a flowchart illustrating an example of a flow of processing relating to a presentation of the gaming machine of FIG. 1.

FIG. 10 is a flowchart illustrating an example of a flow of presentation processing by the presentation device of FIG. 1.

FIG. 11 is a schematic perspective view of a gaming machine provided with a presentation device according to a modification of an embodiment.

### DESCRIPTION OF THE EMBODIMENTS

One aspect of the disclosure provides a presentation device in which player interest and visibility are enhanced.

A presentation device according to aspect 1 of the disclosure is a presentation device provided in a gaming machine. The presentation device includes: a plurality of roulette wheels, having different diameters from each other and rotatably held on the same rotation center line; a plurality of motors, rotating the plurality of roulette wheels; a communication part, transmitting and receiving a control signal to and from the gaming machine; and a control part, controlling the plurality of motors based on the control signal received by the communication part from the gaming machine.

According to the above configuration, based on the control signal from the gaming machine, the control part controls the motor to rotate the plurality of roulette wheels having different diameters from each other and arranged concentrically. Accordingly, a presentation enhanced in interestingness and visibility can be achieved compared to a conventional presentation device configured of a single roulette wheel. Since a plurality of roulette wheels are provided such that results indicated by stopped roulette wheels can be displayed in combinations of stop positions of the roulette wheels, it is possible to achieve a highly interesting presentation that is unable to be achieved with a conventional roulette configured of a single roulette wheel.

In the presentation device according to aspect 2 of the disclosure, in aspect 1 above, the control part may control each of the motors so that at least one of the roulette wheels rotates in a different direction from the others of the roulette wheels.

According to the above configuration, since at least one of the roulette wheels rotates in a different direction from the other roulette wheels, the presentation by the presentation device can be enhanced in interestingness.

In the presentation device according to aspect 3 of the disclosure, in aspect 1 above, the control part may control each of the motors so that at least one of the roulette wheels rotates at a different speed from the others of the roulette wheels.

According to the above configuration, since at least one of the roulette wheels rotates at a different speed from the other roulette wheels, the presentation by the presentation device can be enhanced in interestingness.

In the presentation device according to aspect 4 of the disclosure, in aspect 1 above, the control part may control each of the motors so that at least one of the roulette wheels stops rotating at a different timing from the others of the roulette wheels.

According to the above configuration, among the plurality of roulette wheels, by stopping, for example, only a roulette wheel that indicates a game result of the gaming machine in the end, player interest can further be enhanced.

In the presentation device according to aspect 5 of the disclosure, in aspect 1 above, the presentation device further includes: a light emitting part, emitting light; and a light guide plate, guiding the light emitted from the light emitting part and emitting the light from an emission surface. The control part may control the light emitting part based on the control signal from the gaming machine.

According to the above configuration, by controlling the light emitting part by the control part based on the control signal from the gaming machine, for example, by emitting light from the light guide plate in accordance with the game result of the gaming machine, the presentation by the presentation device can further be enhanced in interestingness.

In the presentation device according to aspect 6 of the disclosure, in aspect 1 above, the plurality of roulette wheels each have a display surface. Each of the display surfaces is arranged so as to face a player while being flush with each other.

According to the above configuration, since the display surfaces of the plurality of roulette wheels are arranged so as to face the player while being flush with each other, the presentation device can be reduced in size.

A gaming machine according to one aspect of the disclosure includes the presentation device according to any one of aspects 1 to 6 above.

According to the above configuration, by controlling the motor by the control part based on the control signal from the gaming machine, after the plurality of roulette wheels having different diameters from each other are rotated, each roulette wheel can be stopped at a position corresponding to the game result. Accordingly, the player is able to understand the game result after watching the presentation of rotation of the plurality of roulette wheels by the presentation device. Thus, player interest can be enhanced.

According to one aspect of the disclosure, a presentation device can be realized in which player interest and visibility are enhanced.

### Embodiment 1

An embodiment (hereinafter also written as “the present embodiment”) according to one aspect of the disclosure is hereinafter described based on the drawings. The same or equivalent portions in the drawings will be denoted by the same reference numerals, and description thereof will not be repeated.

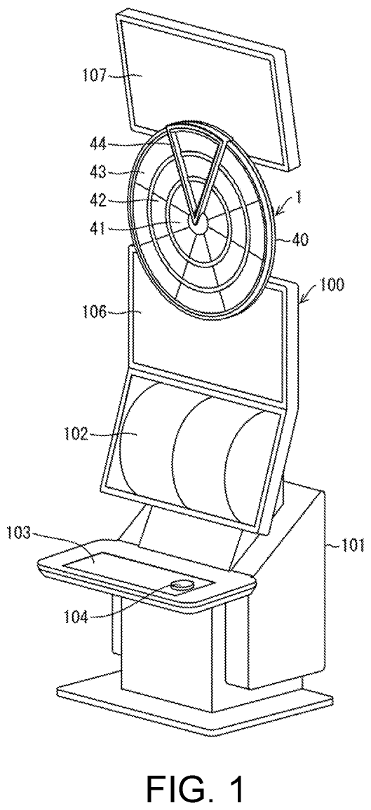

Hereinafter, one embodiment of the disclosure will be described with reference to FIG. 1 to FIG. 10. However, the present embodiment described below is merely an example of the disclosure in all respects. It goes without saying that various improvements or modifications can be made without departing from the scope of the disclosure. That is, when implementing the disclosure, a specific configuration corresponding to the embodiment may be adopted as appropriate.

§ 1 Application Example

First of all, described is an example of a situation in which the disclosure is applied. FIG. 1 is a schematic perspective view of a gaming machine 100 provided with a presentation device 1 according to an embodiment of the disclosure. As illustrated in FIG. 1, the presentation device 1 is provided in the gaming machine 100. The gaming machine 100 is installed in an amusement facility such as a casino.

In the gaming machine 100, a first display part 102 displaying an image of a reel or the like is provided on a front surface side of a housing 101. In addition to the first display part 102, a reel that actually rotates may be provided.

An operation part 103 and a start button 104 are provided below the first display part 102. The operation part 103 may, for example, display a BET screen or the like for setting the number of bets, and receive the setting of the number of bets or the like. The start button 104 is a depression type push button and is so-called a SPIN button. When the start button 104 is depressed, a game lottery is performed and a reel starts rotating. The reel stops at pattern corresponding to a result of the game lottery.

A second display part 106 is provided above the first display part 102. The second display part 106 displays, for example, an animation image or the like for presentation. The presentation device 1 described later is attached above the second display part 106. The presentation device 1 is a device for performing a presentation corresponding to a result of a game by the gaming machine 100.

A third display part 107 of the gaming machine 100 is provided above the presentation device 1. The third display part 107 displays, for example, the number of valuable value media such as medals to be dispensed to a player according to the result of the game lottery by the gaming machine 100.

In FIG. 1, a slot machine exemplifies the gaming machine 100. However, the disclosure is not limited thereto. The presentation device 1 can also be used in various gaming machines such as a poker machine, a pachinko machine, and a pachislot machine.

§ 2 Configuration Example

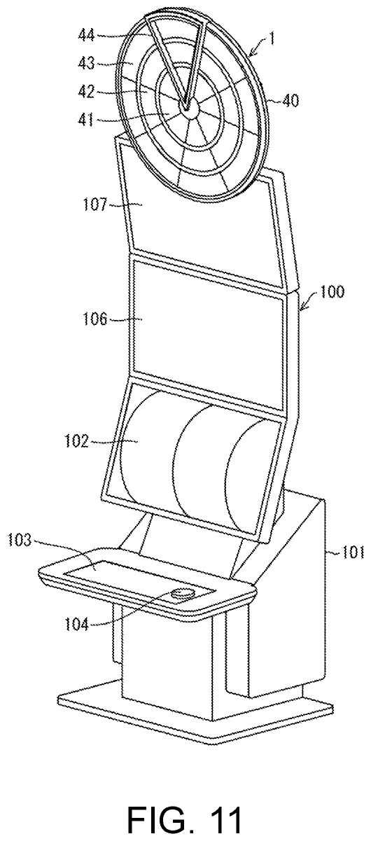

Next, a configuration of the presentation device 1 of the present embodiment is described in detail with reference to FIG. 1 to FIG. 11. As illustrated in FIG. 1, the presentation device 1 includes three roulette wheels, namely, a small roulette wheel 41, a medium roulette wheel 42, and a large roulette wheel 43. The number of roulette wheels in the presentation device 1 is not limited to three. It suffices if the number is two or more. For example, the number may be four. The presentation device 1 is arranged between the second display part 106 and the third display part 107 of the gaming machine 100. The arrangement and configuration of the presentation device 1 are not limited to those illustrated in FIG. 1. The presentation device 1 may be, for example, arranged above the third display part 107 as illustrated in FIG. 11.

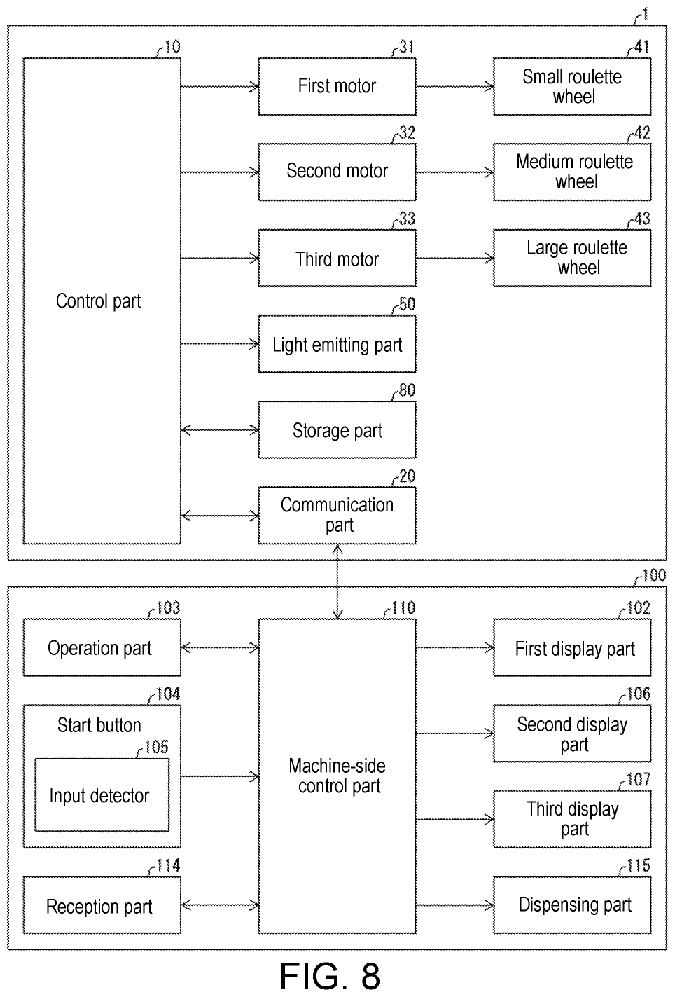

Rotation of the small roulette wheel 41, the medium roulette wheel 42, and the large roulette wheel 43 is controlled by a control part 10 illustrated in FIG. 8 according to the game result of the gaming machine 100. Specifically, the control part 10 controls driving of a first motor 31, a second motor 32, and a third motor 33 respectively corresponding to the small roulette wheel 41, the medium roulette wheel 42, and the large roulette wheel 43, thereby controlling the rotation of each of the small roulette wheel 41, the medium roulette wheel 42, and the large roulette wheel 43. Accordingly, a rotation speed or rotation direction of each of the small roulette wheel 41, the medium roulette wheel 42 and the large roulette wheel 43 can be individually controlled.

That is, the control part 10 is able to control the first motor 31, the second motor 32, and the third motor 33 so that at least one of the small roulette wheel 41, the medium roulette wheel 42, and the large roulette wheel 43 rotates in a different direction from the other roulette wheels.

The control part 10 is able to control the first motor 31, the second motor 32, and the third motor 33 so that at least one of the small roulette wheel 41, the medium roulette wheel 42, and the large roulette wheel 43 rotates at a different speed from the other roulette wheels.

That is, it is possible for the control part 10 to, for example, cause the medium roulette wheel 42 to rotate in a different direction from the small roulette wheel 41 and the large roulette wheel 43, and also cause the small roulette wheel 41 and the large roulette wheel 43 to rotate at different speeds from each other.

The control part 10 is able to control the first motor 31, the second motor 32, and the third motor 33 so that at least one of the small roulette wheel 41, the medium roulette wheel 42, and the large roulette wheel 43 stops rotating at a different timing from the other roulette wheels.

That is, it is possible for the control part 10 to cause the small roulette wheel 41, the medium roulette wheel 42, and the large roulette wheel 43 to stop rotating at different timings from each other. The control part 10 is able to stop the small roulette wheel 41, the medium roulette wheel 42, and the large roulette wheel 43 at a stop position corresponding to the game result of the gaming machine 100.

Accordingly, by visually recognizing the presentation device 1, the player can enjoy a presentation accompanied by the rotation of the three roulette wheels 41 to 43. The content of the presentation may vary according to the result of the game lottery of the gaming machine 100, and player interest can be enhanced. Since the presentation device 1 is provided above the first display part 102 of the gaming machine 100, the visibility for the player with respect to the presentation by the presentation device 1 can be enhanced.

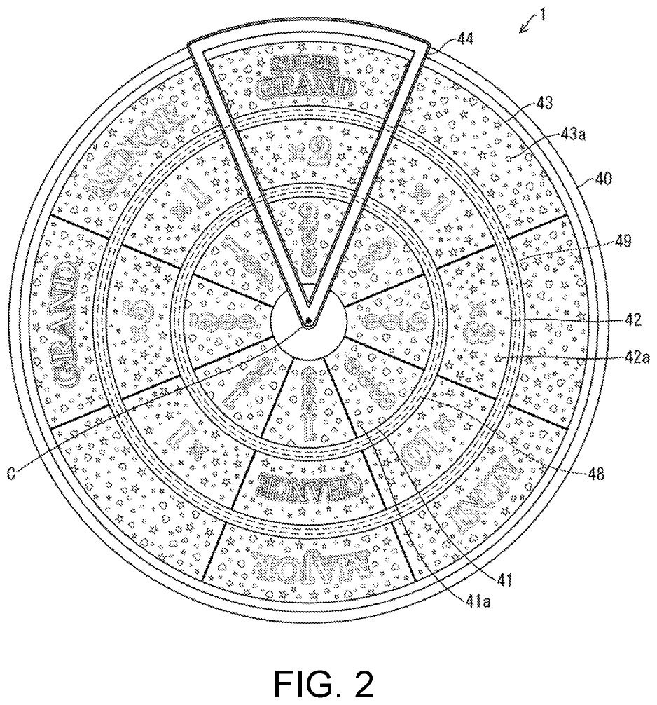

FIG. 2 is an enlarged front view of the presentation device 1. As illustrated in FIG. 2, the presentation device 1 has a disk-like outer shape. In the presentation device 1, the small roulette wheel 41, the medium roulette wheel 42, and the large roulette wheel 43 having different diameters from each other are arranged in order from the inside in a radial direction.

The small roulette wheel 41, the medium roulette wheel 42, and the large roulette wheel 43 are annular rotating bodies, and are rotatably held about a rotation center line C. The small roulette wheel 41 has a display surface 41a. The medium roulette wheel 42 has a display surface 42a. The large roulette wheel 43 has a display surface 43a.

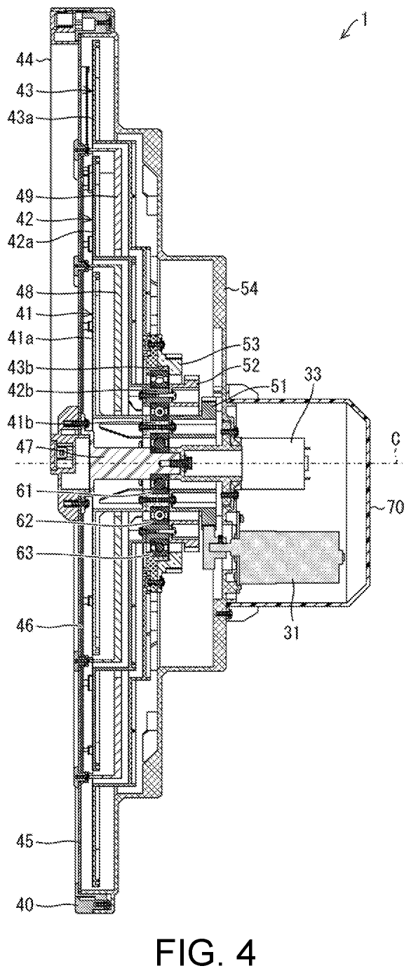

The display surface 41a of the small roulette wheel 41, the display surface 42a of the medium roulette wheel 42 and the display surface 43a of the large roulette wheel 43 are arranged to face the player while being flush with each other (see FIG. 4). The display surface 41a of the small roulette wheel 41, the display surface 42a of the medium roulette wheel 42 and the display surface 43a of the large roulette wheel 43 are each divided into a plurality of blocks, for example, eight blocks.

The small roulette wheel 41 has the smallest diameter among the three roulette wheels 41 to 43. The display surface 41a of the small roulette wheel 41 displays, for example, a number relating to prize money of the game lottery. In the example illustrated in FIG. 2, in each division of the display surface 41a of the small roulette wheel 41, the amounts “50”, “100”, “150”, “200”, “500”, “1000”, “2000” and “3000” are displayed.

The medium roulette wheel 42 has a larger diameter than the small roulette wheel 41. The display surface 42a of the medium roulette wheel 42 displays, for example, a number or the like relating to a multiplying factor. In the example illustrated in FIG. 2, in each division of the display surface 42a of the medium roulette wheel 42, multiplying factors such as “×1”, “×2”, “×3”, “×5” and “×10” and characters “CHANCE” are displayed. The display of “CHANCE” represents, for example, a multiplying factor greater than 10 times.

The large roulette wheel 43 has the largest diameter among the three roulette wheels 41 to 43. The display surface 43a of the large roulette wheel 43 displays, for example, a character relating to a type of win. In the example illustrated in FIG. 2, in each division of the display surface 43a of the large roulette wheel 43, characters “SUPER GRAND”, “GRAND”, “MAJOR”, “MINOR”, and “MINI” are displayed. Different multiplying factors are respectively set for these wins. On the display surface 43a, a division where no character relating to a type of win is displayed represents a “loss”. The numbers or characters displayed on the display surface 41a, the display surface 42a, and the display surface 43a are examples, and can be changed as appropriate.

A jackpot frame 44 of a fan shape is provided in a position corresponding to one division of the small roulette wheel 41, the medium roulette wheel 42, and the large roulette wheel 43. The jackpot frame 44 is a member for notifying the player of the result of the game lottery performed by the gaming machine 100, and is fixed to a cover 40. The display inside the jackpot frame 44 is the result of the game lottery.

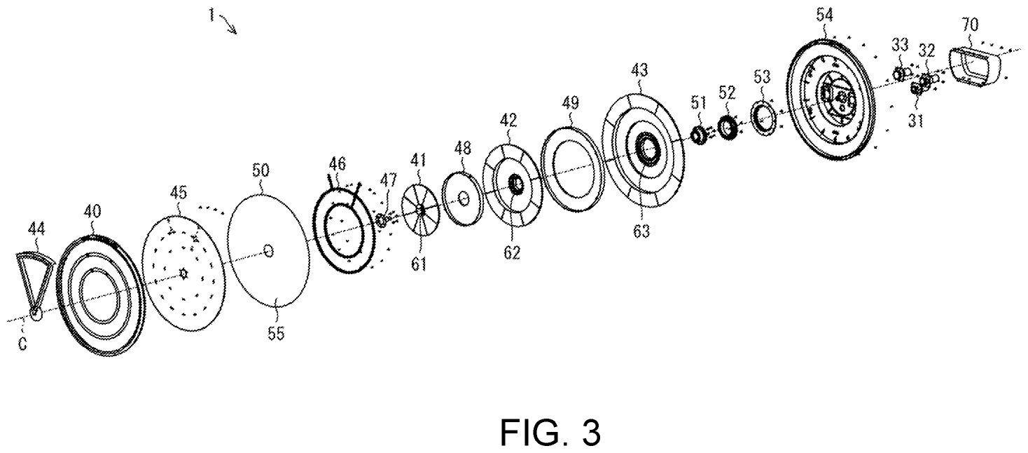

FIG. 3 is an exploded perspective view of the presentation device 1. FIG. 4 is a side cross-sectional view of the presentation device 1. As illustrated in FIG. 3 and FIG. 4, the presentation device 1 further includes the cover 40, a transparent plate 45, a light emitting part 50, a light guide plate 55, a fixing member 46, a fixing shaft 47, a first partition plate 48, a second partition plate 49, a small gear 51, a medium gear 52, a large gear 53, a base member 54, the first motor 31, the second motor 32, the third motor 33, a small bearing 61, a medium bearing 62, a large bearing 63, and a case 70.

The cover 40 and the transparent plate 45 are, for example, made of resin, are arranged closer to the player than the small roulette wheel 41, the medium roulette wheel 42, and the large roulette wheel 43, and protect a surface of each of the roulette wheels 41 to 43 from the outside. The fixing member 46 is a member for fixing the transparent plate 45 and the light guide plate 55 to the cover 40. In FIG. 4, the light guide plate 55 and the light emitting part 50 are omitted. The surface of each of the roulette wheels 41 to 43 refer to a surface on the player side.

The light guide plate 55 is a light guide plate that guides light incident from the light emitting part 50 and emits the light from an emission surface. The light guide plate 55 is composed of a light transmissive member made of acrylic resin or glass or the like, and is a transparent thin plate member. In the light guide plate 55, minute recesses for emitting light are formed in a pattern intended to be visually recognized. In the present embodiment, a pattern for illuminating at least a jackpot area inside the jackpot frame 44 is formed.

The light emitting part 50, for example, has a configuration in which a full-color capable light emitting diode (LED) capable of changing color is arranged on a flexible tape-shaped substrate. The light emitting part 50 is arranged to face an end face of the light guide plate 55 and supplies light to the inside of the light guide plate 55 from the end face.

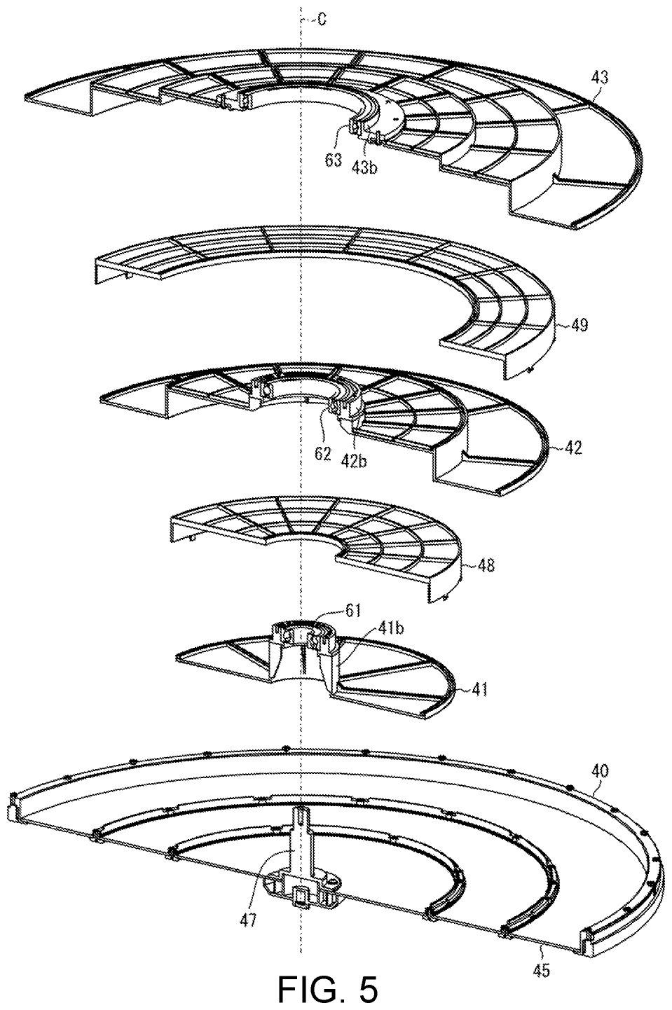

FIG. 5 is an exploded perspective view of a peripheral member of each of the roulette wheels 40 to 43 of the presentation device 1. As illustrated in FIG. 5, on a back surface side of the cover 40, the small roulette wheel 41, the first partition plate 48, the medium roulette wheel 42, the second partition plate 49, and the large roulette wheel 43 are arranged in this order on the same rotation center line C.

The first partition plate 48 of an annular shape is arranged between the small roulette wheel 41 and the medium roulette wheel 42. As illustrated in FIG. 2, the first partition plate 48 is a member for providing a partition between the display surface 41a of the small roulette wheel 41 and the display surface 42a of the medium roulette wheel 42. The first partition plate 48 has a diameter larger than the diameter of the small roulette wheel 41 and smaller than the diameter of the medium roulette wheel 42.

The second partition plate 49 is arranged between the medium roulette wheel 42 and the large roulette wheel 43. As illustrated in FIG. 2, the second partition plate 49 is a member for providing a partition between the display surface 42a of the medium roulette wheel 42 and the display surface 43a of the large roulette wheel 43. The second partition plate 49 has a diameter larger than the diameter of the medium roulette wheel 42 and smaller than the diameter of the large roulette wheel 43.

The small roulette wheel 41, the first partition plate 48, the medium roulette wheel 42, the second partition plate 49, and the large roulette wheel 43 are mounted and inserted into the fixing shaft 47 in this order.

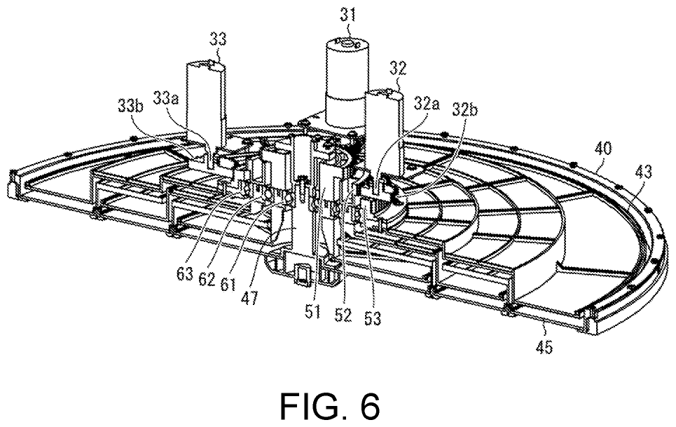

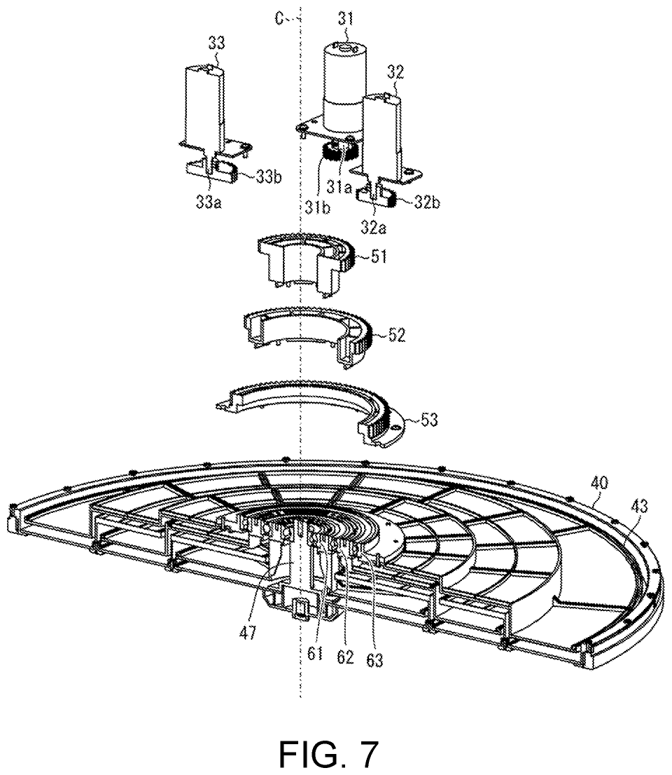

FIG. 6 is a perspective view illustrating a longitudinal section of a peripheral member of each of the motors 31 to 33 of the presentation device 1. FIG. 7 is an exploded perspective view of a peripheral member of each of the motors 31 to 33 of the presentation device 1. As illustrated in FIG. 6 and FIG. 7, a first gear 31b is attached to a rotating shaft 31a of the first motor 31. The first gear 31b meshes with the small gear 51 fixed to the small roulette wheel 41. The small gear 51 is an annular gear having teeth formed on its outer peripheral surface, and is fixed to a convex part 41b of a cylindrical shape protruding toward a back surface side at an edge of an opening in the center of the small roulette wheel 41.

Accordingly, a driving force of the first motor 31 is transmitted to the small roulette wheel 41 via the first gear 31b and the small gear 51, thereby rotating the small roulette wheel 41.

A second gear 32b is attached to a rotating shaft 32a of the second motor 32. The second gear 32b meshes with the medium gear 52 fixed to the medium roulette wheel 42. The medium gear 52 is an annular gear having teeth formed on its outer peripheral surface, and is fixed to a convex part 42b of a cylindrical shape protruding toward the back surface side at an edge of an opening in the center of the medium roulette wheel 42.

Accordingly, a driving force of the second motor 32 is transmitted to the medium roulette wheel 42 via the second gear 32b and the medium gear 52, thereby rotating the medium roulette wheel 42.

A third gear 33b is attached to a rotating shaft 33a of the third motor 33. The third gear 33b meshes with the large gear 53 fixed to the large roulette wheel 43. The large gear 53 is an annular gear having teeth formed on its outer peripheral surface, and is fixed to a convex part 43b of an annular shape protruding toward the back surface side at an edge of an opening in the center of the large roulette wheel 43.

Accordingly, a driving force of the third motor 33 is transmitted to the large roulette wheel 43 via the third gear 33b and the large gear 53, thereby rotating the large roulette wheel 43.

As illustrated in FIG. 4 to FIG. 6, an inner ring of the small bearing 61 is fixed to an outer periphery of the fixing shaft 47. An outer ring of the small bearing 61 is fixed to an inner peripheral surface of the convex part 41b of the small roulette wheel 41. Accordingly, it is possible for the small roulette wheel 41 to rotate smoothly with respect to the fixing shaft 47.

An inner ring of the medium bearing 62 is fixed to an outer peripheral surface of the convex part 41b of the small roulette wheel 41, and an outer ring of the medium bearing 62 is fixed to an inner peripheral surface of the convex part 42b of the medium roulette wheel 42. Accordingly, it is possible for the medium roulette wheel 42 to rotate smoothly with respect to the convex part 41b of the small roulette wheel 41.

An inner ring of the large bearing 63 is fixed to an outer peripheral surface of the convex part 42b of the medium roulette wheel 42, and an outer ring of the large bearing 63 is fixed to an inner peripheral surface of the convex part 43b of the large roulette wheel 43. Accordingly, it is possible for the large roulette wheel 43 to rotate smoothly with respect to the convex part 42b of the medium roulette wheel 42.

In the first motor 31, the second motor 32, and the third motor 33, a stepping motor, for example, can be used. By controlling the number of steps of each of the motors 31 to 33, the control part 10 causes the small roulette wheel 41, the medium roulette wheel 42, and the large roulette wheel 43 to stop at a desired position. The first motor 31, the second motor 32, and the third motor 33 are accommodated in the case 70.

(Electrical Configuration of Presentation Device 1 and Gaming Machine 100)

FIG. 8 is a block diagram illustrating an electrical configuration of the presentation device 1 and the gaming machine 100. As illustrated in FIG. 8, the presentation device 1 further includes a communication part 20 and a storage part 80. The first motor 31, the second motor 32, the third motor 33, the storage part 80, and the communication part 20 are each electrically connected to the control part 10.

By driving forward rotation of the first motor 31, the control part 10 causes the small roulette wheel 41 to rotate clockwise in FIG. 2. On the other hand, by driving reverse rotation of the first motor 31, the control part 10 causes the small roulette wheel 41 to rotate counterclockwise in FIG. 2.

By driving forward rotation of the second motor 32, the control part 10 causes the medium roulette wheel 42 to rotate clockwise in FIG. 2. On the other hand, by driving reverse rotation of the second motor 32, the control part 10 causes the medium roulette wheel 42 to rotate counterclockwise in FIG. 2.

By driving forward rotation of the third motor 33, the control part 10 causes the large roulette wheel 43 to rotate clockwise in FIG. 2. On the other hand, by driving reverse rotation of the third motor 33, the control part 10 causes the large roulette wheel 43 to rotate counterclockwise in FIG. 2.

By adjusting a speed of the first motor 31, the second motor 32, and the third motor 33, the control part 10 adjusts the rotation speed of each of the small roulette wheel 41, the medium roulette wheel 42, and the large roulette wheel 43.

By controlling the light emitting part 50, the control part 10 controls lighting of the LED. The control part 10 transmits and receives a control signal or the like to and from a machine-side control part 110 of the gaming machine 100 via the communication part 20. The storage part 80 stores, for example, a presentation code corresponding to the result of the game lottery.

The gaming machine 100 further includes a reception part 114 and a dispensing part 115. An operation part 103, a start button 104, an input detector 105, the reception part 114, the first display part 102, the second display part 106, the third display part 107, and the dispensing part 115 are each electrically connected to the machine-side control part 110.

The machine-side control part 110 displays a BET screen or the like on the operation part 103, and receives information on the number of bets or the like based on a touch operation performed by the player on the operation part 103. When receiving an operation of the start button 104 performed by the player, the machine-side control part 110 displays an image of a rotating reel on the first display part 102 and performs a game lottery.

After that, the machine-side control part 110 transmits the presentation code corresponding to the result of the game lottery performed by the gaming machine 100 to the communication part 20 of the presentation device 1. Based on the presentation code received by the communication part 20, the control part 10 executes presentation processing described later.

The machine-side control part 110 displays a presentation image or the like corresponding to the result of the game lottery on the second display part 106, and displays information on the result of the game lottery or the like on the third display part 107. The reception part 114 receives a valuable value medium such as a medal or an integrated circuit (IC) card for performing the game lottery. The dispensing part 115 dispenses a medal or the like according to the result of the game lottery.

§ 3 Operation Example

(Flow of Processing Relating to Presentation of Gaming Machine 100)

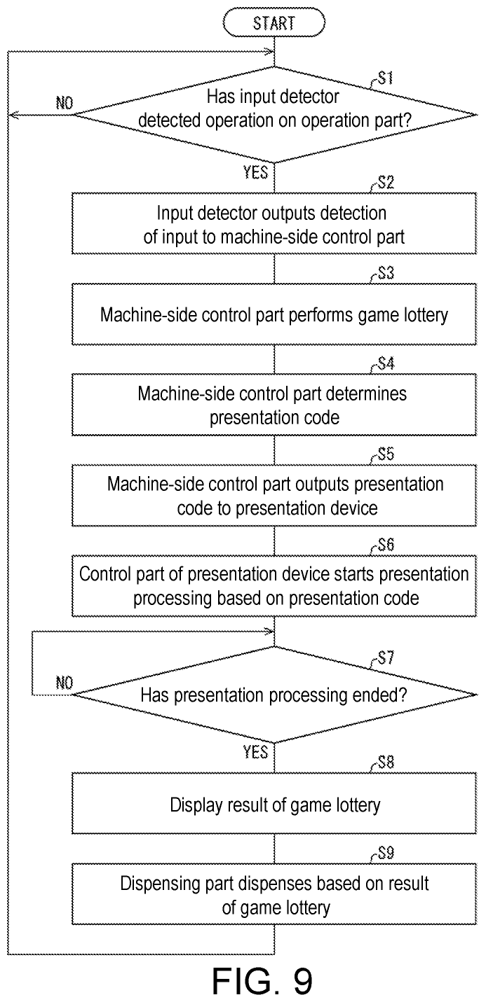

Next, an operation of the gaming machine 100 is described with reference to FIG. 9. FIG. 9 is a flowchart illustrating an example of a flow of processing relating to a presentation of the gaming machine 100.

As illustrated in FIG. 9, the input detector 105 always detects whether the start button 104 has been operated (S1). When the player operates the start button 104, the input detector 105 detects the operation on the start button 104 (S1: YES), and outputs a signal indicating detection of input to the machine-side control part 110 (S2).

After S2, the machine-side control part 110 performs game lottery processing (S3). In S3, the machine-side control part 110 determines a winning role such as “jackpot”, “small jackpot”, or “loss” by performing the game lottery processing.

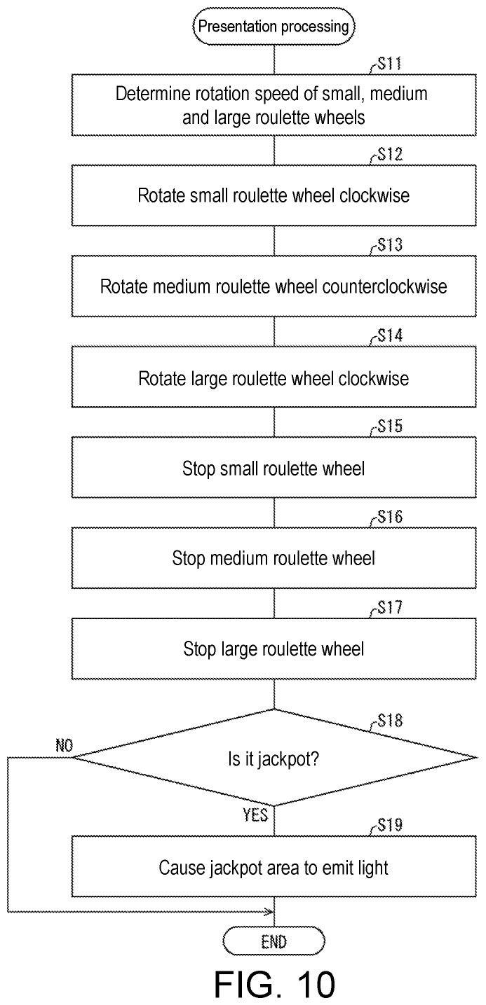

After S3, the machine-side control part 110 determines a presentation code corresponding to the winning role (S4), and outputs the presentation code to the control part 10 of the presentation device 1 via the communication part 20 (S5). After S5, the control part 10 of the presentation device 1 starts presentation processing based on the presentation code illustrated in FIG. 10 (S6). The presentation code may include a presentation other than the presentation by the presentation device 1. For example, a presentation image may be displayed on the second display part 106.

After S6, the control part 10 determines whether the presentation processing by the presentation device 1 has ended (S7). Specifically, the control part 10 determines whether the player has performed on the operation part 103 a predetermined operation for determining the end of the presentation, or whether a predetermined time has passed since the presentation device 1 started the presentation processing.

If the control part 10 determines that the presentation processing by the presentation device 1 has ended (S7: YES), the control part 10 displays a result of the game lottery of the gaming machine 100 on the first display part 102 (S8). After S8, the dispensing part 115 dispenses a medal or the like based on the result of the game lottery (S9).

After S9, if the predetermined time has passed and the presentation processing has ended in S7, the machine-side control part 110 returns to S1 and waits for an operation on the start button 104 for the next game lottery. On the other hand, if the operation for starting the next game lottery is performed by the start button 104 in S7, the machine-side control part 110 determines YES in S1 and advances to S2. In this way, the processing relating to the presentation of the gaming machine 100 is performed.

(Flow of Presentation Processing by Presentation Device 1)

Next, an example of the presentation processing by the presentation device 1 is described with reference to FIG. 10. FIG. 10 is a flowchart illustrating an example of a flow of the presentation processing by the presentation device 1. In the presentation processing illustrated in FIG. 10, the control part 10 performs a mini game presentation corresponding to the type of winning role described above.

First, the control part 10 of the presentation device 1 determines a rotation speed of the small roulette wheel 41, the medium roulette wheel 42 and the large roulette wheel 43 according to the result of the game lottery processing of the gaming machine 100 (S11). The small roulette wheel 41, the medium roulette wheel 42, and the large roulette wheel 43 may have different rotation speeds from each other or may have the same rotation speed.

Subsequently, by driving forward rotation of the first motor 31, the control part 10 causes the small roulette wheel 41 to rotate clockwise at the rotation speed determined in S11 (S12). By driving reverse rotation of the second motor 32, the control part 10 causes the medium roulette wheel 42 to rotate counterclockwise at the rotation speed determined in S11 (S13). Then, by driving forward rotation of the third motor 33, the control part 10 causes the large roulette wheel 43 to rotate clockwise at the rotation speed determined in S11 (S14).

The result of the game lottery processing of the gaming machine 100, that is, the rotation speed and rotation direction of each of the roulette wheels 40 to 43 corresponding to each winning role, have been stored in advance in the storage part 80. The content of the processing of S12 to S14 is an example, and may be changed as appropriate according to each winning role.

Next, by controlling the first motor 31, the control part 10 causes the small roulette wheel 41 to stop at a position corresponding to the result of the game lottery processing (S15). In the example illustrated in FIG. 2, the small roulette wheel 41 stops at a position where the display surface 41a on which the number “2000” is displayed falls within the jackpot frame 44. This allows the player to understand that there is a possibility of obtaining, as prize money, an amount obtained by multiplying 2000 yen by the multiplying factor.

After S15, by controlling the second motor 32, the control part 10 causes the medium roulette wheel 42 to stop at a position corresponding to the result of the game lottery processing (S16). In the example illustrated in FIG. 2, the medium roulette wheel 42 stops at a position where the display surface 42a on which the number “×2” is displayed falls within the jackpot frame 44. This allows the player to understand that prize money such as a medal equivalent to 4000 yen, which is double the amount of 2000 yen, may be obtained, and the player's expectations for a “jackpot” can be raised.

After S16, by controlling the third motor 33, the control part 10 causes the large roulette wheel 43 to stop at a position corresponding to the result of the game lottery processing (S17). In the example illustrated in FIG. 2, the large roulette wheel 43 stops at a position where the display surface 43a on which the characters “SUPER GRAND” are displayed falls within the jackpot frame 44. This allows the player to understand that the result of the game lottery is a “jackpot”.

After S17, the control part 10 determines whether the result of the game lottery processing is a jackpot (S18); if it is a jackpot (S18: YES), the control part 10 causes a jackpot area being an area inside the jackpot frame 44 to emit light (S19). Accordingly, by the light emitted from the surface of the light guide plate 55, a number or character in the jackpot area is relatively clearly displayed. According to the type of win, the light emitted from the light emitting part 50 may be changed in color.

On the other hand, if the result of the game lottery processing is not a jackpot (S18: NO), or after S19, the control part 10 ends the presentation processing illustrated in FIG. 10.

§ 4 Action and Effects

In the presentation by the presentation device 1 of the present embodiment described above, by controlling each of the motors 31 to 33 by the control part 10 based on the control signal from the gaming machine 100, three roulette wheels having different diameters from each other, namely, the small roulette wheel 41, the medium roulette wheel 42, and the large roulette wheel 43, are coaxially rotated. Accordingly, the presentation by the presentation device 1 can be enhanced in interestingness and visibility.

Since a plurality of roulette wheels are provided such that results indicated by stopped roulette wheels can be displayed in combinations of stop positions of the roulette wheels, it is possible to achieve a highly interesting presentation that is unable to be achieved with a conventional roulette configured of a single roulette wheel.

Since a plurality of roulette wheels are rotatably held on the same rotation center line, the player only needs to focus their eye on the vicinity of the rotation center line of the plurality of roulette wheels, and the visibility of the presentation device can be enhanced.

For example, by causing the medium roulette wheel 42 to rotate in a different direction from the small roulette wheel 41 and the large roulette wheel 43 and causing the small roulette wheel 41, the medium roulette wheel 42, and the large roulette wheel 43 to rotate at different speeds from each other, player interest can be enhanced.

For example, the roulette wheels 41 to 43 are stopped in the order of the small roulette wheel 41, the medium roulette wheel 42, and the large roulette wheel 43. Accordingly, the player will confirm the display of the large roulette wheel 43 indicating the result of the game lottery in the end, and player interest can further be enhanced.

By providing the light guide plate 55 and the light emitting part 50, for example, it is possible to cause the jackpot area being the area inside the jackpot frame 44 of the light guide plate 55 to emit light. Accordingly, a presentation using light in accordance with the game result of the gaming machine 100 can be added, and the presentation by the presentation device 1 can further be enhanced in interestingness and visibility.

Since the display surface 41a of the small roulette wheel 41, the display surface 42a of the medium roulette wheel 42 and the display surface 43a of the large roulette wheel 43 are arranged to face the player while being flush with each other, the length of the presentation device 1 in the direction of the rotation center line C can be reduced, and the presentation device 1 can be reduced in thickness.

§ 5 Modifications

In the presentation device 1 of the embodiment described above, the display surface 41a of the small roulette wheel 41, the display surface 42a of the medium roulette wheel 42 and the display surface 43a of the large roulette wheel 43 are arranged flush with each other. However, the disclosure is not limited thereto, and the display surfaces 41a to 43a may be arranged in a stepped manner.

In the presentation device 1 of the embodiment described above, the control part 10 stops the roulette wheels 41 to 43 in the order of the small roulette wheel 41, the medium roulette wheel 42, and the large roulette wheel 43 in S15 to S17. However, the disclosure is not limited thereto. The order in which the roulette wheels 41 to 43 are stopped may be changed, or the roulette wheels 41 to 43 may be stopped at the same time. The rotation speed of each of the roulette wheels 41 to 43 may be reduced in stages by the control part 10.

In the presentation device 1 of the embodiment described above, by controlling the number of steps of each of the motors 31 to 33, the control part 10 causes each of the roulette wheels 41 to 43 to stop at the desired position. However, the disclosure is not limited thereto. Each of the motors 31 to 33 may be provided with an encoder detecting the number of revolutions of the motor, and, based on a detection result of each encoder, the rotation of each of the roulette wheels 41 to 43 may be controlled by the control part 10.

In the presentation device 1 of the embodiment described above, the presentation code transmitted from the gaming machine 100 to the control part 10 corresponds to the result of the game lottery of the gaming machine 100. However, the disclosure is not limited thereto. The presentation device 1 may, for example, perform the presentation processing according to a progress of various games in the gaming machine 100.

The disclosure is not limited to the embodiments described above, and may be modified in various ways within the scope of the claims. An embodiment derived from a proper combination of technical means disclosed in respective different embodiments is also encompassed in the technical scope of the disclosure.

What is claimed is:

1. A presentation device provided in a gaming machine, comprising:
a plurality of roulette wheels, having different diameters from each other and rotatably held on a same rotation center line;
a plurality of motors, rotating the plurality of roulette wheels;
a communication part, transmitting and receiving a control signal to and from the gaming machine; and
a control part, controlling the plurality of motors based on the control signal received by the communication part from the gaming machine.

2. The presentation device according to claim 1, wherein
the control part controls each of the plurality of motors so that at least one of the plurality of roulette wheels rotates in a different direction from the others of the plurality of roulette wheels.

3. The presentation device according to claim 1, wherein
the control part controls each of the plurality of motors so that at least one of the plurality of roulette wheels rotates at a different speed from the others of the plurality of roulette wheels.

4. The presentation device according to claim 1, wherein
the control part controls each of the plurality of motors so that at least one of the plurality of roulette wheels stops rotating at a different timing from the others of the plurality of roulette wheels.

5. The presentation device according to claim 1, further comprising:
a light emitting part, emitting light; and
a light guide plate, guiding the light emitted from the light emitting part and emitting the light from an emission surface, wherein
the control part controls the light emitting part based on the control signal from the gaming machine.

6. The presentation device according to claim 1, wherein
the plurality of roulette wheels each have a display surface, and
each of the display surfaces is arranged so as to face a player while being flush with each other.

7. A gaming machine, comprising the presentation device according to claim 1.
